(19) United States
(12) Patent Application Publication
(10) Pub. No.: US 2006/0255164 A1
(43) Pub. Date: Nov. 16, 2006

(54) Remote sensing system for a dehumidifier

(75) Inventors: Sven Oppermann, Ancaster (CA); Wesley John Fuller, Paris (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: W.C. Wood Company Limited

(21) Appl. No.: 11/128,738

(22) Filed: May 13, 2005

(51) Int. Cl. G05D 23/00; F25D 17/06; F25D 17/04; F25B 49/00

(52) U.S. Cl. 236/44 C; 236/51; 62/176.6

(57) ABSTRACT

A dehumidifier comprising a dehumidifier main body portion, a receiver board, and a remote control. The dehumidifier main body portion includes a dehumidification system. The receiver board is mounted on the main body portion for controlling operation of the dehumidification system. The remote control includes a control circuit for generating a control signal and a transmitter for wirelessly transmitting the control signal to the receiver board. The remote control further includes a sensor electrically coupled to the control circuit. The sensor generates a sensor signal in response to a physical condition sensed at the location of the remote control. The control signal is based upon the sensor signal and the receiver board controls the dehumidification system in response to the control signal.

### FIELD OF THE INVENTION

The present invention relates to climate control and, more particularly, to a remote sensor for a dehumidifier.

### BACKGROUND OF THE INVENTION

Conventional dehumidifiers have a humidistat integrated in the dehumidifier to sense when a desired humidity level is achieved at the location of the dehumidifier. Because dehumidifiers are typically large, noisy devices, users often wish to place dehumidifiers in remote locations as far away from the living area of the home as possible. The distance between the dehumidifier and the living area in which the user is trying to control the humidity level results in the integrated humidistat providing a humidity level reading to the dehumidifier that is not accurate from the perspective of the user. Typically, in setting the desired humidity level on the dehumidifier, the user wishes to control the humidity level in the living area of the home, not in the space immediately surrounding the remotely placed dehumidifier. As a result, conventional dehumidifiers serve a limited purpose because of the discrepancy between the setting the user sets on the dehumidifier and the resulting humidity level achieved by the dehumidifier in the living area of the home.

It would be desirable to have a dehumidifier that does not suffer from the requirement of having an integrated humidistat. It would also be desirable to have a dehumidifier that can be remotely placed and still achieve an accurate humidity level in the living area of the home as set by the user.

### SUMMARY OF THE INVENTION

The present invention provides a system for remote sensing for a dehumidifier. In one aspect, a remote control is provided with integrated temperature and humidity sensors so that a desired humidity level is achieved at the location of the remote control.

In accordance with one aspect of the present invention, a dehumidifier is provided comprising a dehumidifier main body portion, a receiver board, and a remote control. The dehumidifier main body portion includes a dehumidification system. The receiver board is mounted on the main body portion for controlling operation of the dehumidification system. The remote control includes a control circuit for generating a control signal and a transmitter for wirelessly transmitting the control signal to the receiver board. The remote control further includes a sensor electrically coupled to the control circuit. The sensor generates a sensor signal in response to a physical condition sensed at the location of the remote control. The control signal is based on the sensor signal and the receiver board controls the dehumidification system in response to the control signal.

The sensor may comprise either a humidistat or a thermometer. The dehumidifier may further comprise one or more buttons located on the remote control and coupled to the control circuit and a display located on the remote control and coupled to the control circuit. A user of the dehumidifier may input a set point using the one or more buttons and the control circuit generates the control signal based on the sensor signal and the set point. The sensor may comprise a humidistat and the set point may comprise an ambient humidity setting. In one aspect, the remote control may be removably attachable to the receiver board.

The dehumidifier may further comprise a second sensor for sensing physical conditions at the dehumidifier main body portion. The second sensor is electrically coupled to the receiver board and the receiver board controls operation of the dehumidification system in response to the control signal and the second sensor. The second sensor may comprise either a coil temperature sensor for triggering a defrost mode of operation, a level sensor for triggering a full bucket condition, or a humidistat supplying a second control signal to the receiver board. The dehumidification system may be set to operate in response to either the control signal or second control signal. The transmitter may wirelessly transmit the control signal to the receiver board using a wireless communication link. The wireless communication link may comprise a radio frequency (RF) signal, a networking communication link, or a wireless bus protocol communication link.

The dehumidifier may further comprise one or more sensors electrically coupled to the receiver board, one or more switches electrically coupled to the receiver board, and/or one or more light emitting diodes (LEDs) electrically coupled to the receiver board. The one or more sensors may generate additional sensor signals in response to physical conditions sensed at the location of the receiver board. The one or more switches control the operation of the dehumidification system in response to settings set by a user at the location of the dehumidifier main body portion. The one or more LEDs indicate various operating modes of the dehumidification system. The dehumidifier may also comprise a processor mounted on the receiver board for receiving the control signal and controlling the dehumidification system. The processor may be either an application specific integrated circuit (ASIC) or a microcontroller. The dehumidifier may further comprise a housing for the receiver board having a front face with an elevated contour, and a recess complementary to the elevated contour located on the back of the remote control. The remote control may be removably attachable to the housing of the receiver board.

The dehumidifier may form part of a dehumidification network. The dehumidification network may further comprise one or more additional dehumidifier main body portions each including dehumidification systems and one or more additional receiver boards mounted on the one or more additional dehumidifier main body portions, each for controlling operation of the respective dehumidification systems. The control signal further comprises an address code and a unique unit code. The receiver board and the one or more additional receiver boards further comprise a programmed unique unit code. The address code comprises two different codes representing either a one to one mode or a one to all mode. The receiver board and the one or more additional receiver boards all operate in response to the control signal when the address code indicates one to all mode. The receiver board and the one or more additional receiver boards individually operate in response to the control signal when the address code indicates one to one mode and the unique unit code equals the programmed unique unit code.

### BRIEF DESCRIPTION OF THE DRAWINGS

Various features and advantages of the present invention will be apparent from the following detailed description and the appended claims and drawings in which:

FIG. 1 is a front perspective view of a dehumidifier system of an example embodiment of the present invention;

FIG. 2 is a front plan view of a remote control and sensing device of an example embodiment of the present invention;

FIG. 3 is a front perspective view of a receiver board in accordance with an example embodiment of the present invention;

FIG. 4 is a front plan view of the receiver board shown in FIG. 3; and

FIG. 5 is a block diagram illustrating a circuit topology of an example embodiment of the present invention.

Similar reference numerals are used in different figures to denote similar components.

### DETAILED DESCRIPTION OF THE EMBODIMENTS

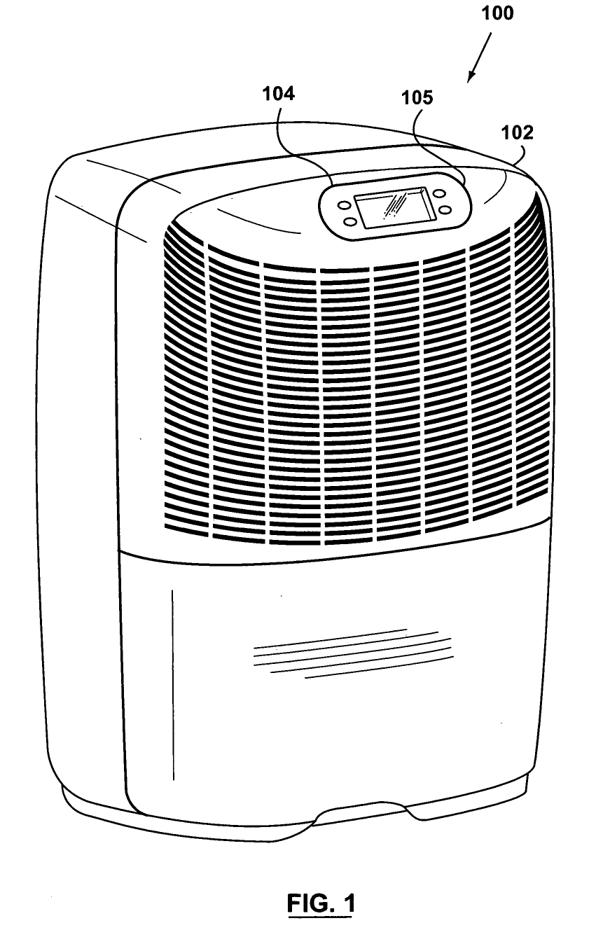

Referring to FIG. 1, a front perspective view of a dehumidifier system 100 is shown in accordance with an example embodiment of the present invention. The dehumidifier system 100 generally comprises a main body 102, a remote control and sensing device 104, and a receiver board 105. In one example, the remote control and sensing device 104 may be removably attached to the main body 102. In another example, the remote control and sensing device 104 may be an entirely separate device that cannot be attached to the main body 102. The receiver board 105 is coupled to the main body 102 and is located behind the remote control and sensing device 104.

The main body 102 has a mechanical dehumidification system contained within the main body 102, which may include a fan, a compressor, and other components, as will be understood by those of ordinary skill in the art.

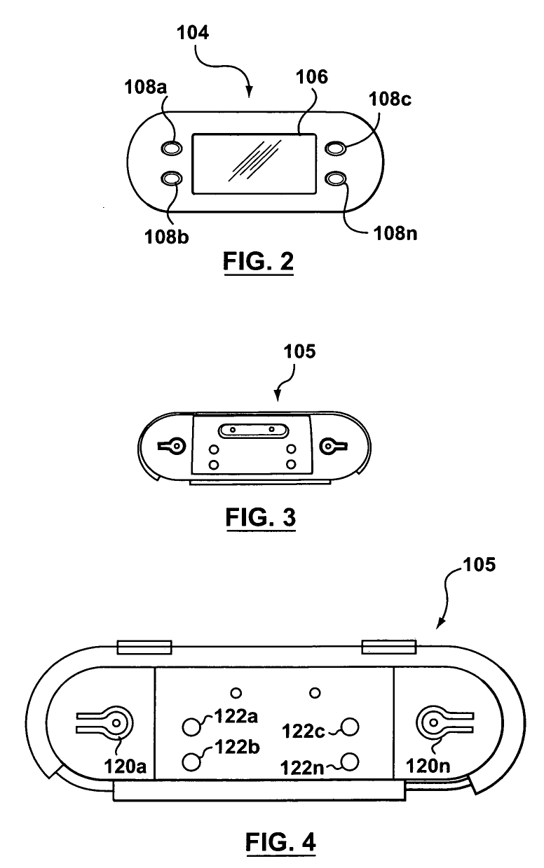

Referring to FIG. 2, a front plan view of the remote control and sensing device 104 is shown. The remote control and sensing device 104 generally comprises a display 106 and a number of buttons 108, individually indicated as 108a, 108b, . . . , 108n. In one example, the buttons 108 comprise a power button 108a, a mode button 108b, an up button 108c, and a down button 108n. The display 106 may be a liquid crystal display (LCD) or any other suitable display known in the art. The display 106 shows the user information about an operating mode of the dehumidifier system 100 (FIG. 1), a humidity level or temperature sensed at either the main body 102 (FIG. 1) or the remote control and sensing device 104, a fan speed of the dehumidifier system 100, a relative humidity set-point as set by the user using the remote control and sensing device 104, an ambient humidity level as sensed at either the remote control and sensing device 104 or the main body 102, a bucket full indicator for the dehumidifier system 100, and/or a buzzer indicator to alert a user of the dehumidifier system 100 to any number of important conditions. Additionally, the remote control and sensing device 104 may include a number of sensors or transducers (described later in connection with FIG. 5) that provide information regarding ambient environmental conditions. In one embodiment, the remote control and sensing device 104 includes an ambient humidity sensor and an ambient temperature sensor.

In one embodiment, the remote control and sensing device 104 allows the user to select an operating mode for the dehumidifier system 100. Example operating modes may include:

1. Power-Off Mode

Using the remote control and sensing device 104, the user may cause the dehumidifier system 100 to enter a power-off mode. In this mode of operation, power is not supplied to the mechanized dehumidification system, including the fan and compressor, the display 106 is off, and any displays and/or outputs on the receiving controller 105 (FIG. 1) are also shut off.

2. Power-On Mode (Operating Mode)

In a power-on or operating mode, the display 106 is on and ambient temperature and ambient relative humidity information is displayed. The display 106 may include a relative humidity setting bar showing the user a user modifiable humidity set-point, initially set at, for example, 35%. The user may set the desired relative humidity set-point using the remote control and sensing device 104. A fan speed display on the display 106 shows the previous fan speed and the initial power-on fan speed (e.g., the fan speed may initially be set to high). In the power-on mode, the compressor and the fan of the dehumidifier system 100 are on if the ambient relative humidity is, for example, 5% higher than the set-point set by the user. Once the ambient relative humidity reaches, for example, 3% below the user's set-point, the compressor and fan are turned off sequentially.

3. Fail-Safe Mode

If the receiver board 105 determines that either the ambient humidity sensor or the ambient temperature sensor in the remote control 104 has failed to work properly, then the receiver board 105 my cause the dehumidifier system 100 to enter a fail-safe mode. In the fail-safe mode, the fan runs with a user selected fan speed and the compressor may cycle with a predetermined duty cycle. In one example embodiment, the predetermined duty cycle may be a sequence of fifty-two minutes on and eight minutes off.

4. Setup Mode

The dehumidifier system 100 may operate in a setup mode while the user enters changes to various settings. The setup mode is activated by pressing the mode button 108b while the dehumidifier system 100 is in the operating mode. Any icons on the display 106 are turned off except for the selected fan speed icon, which will flash. In a setup mode, the remote control and sensing device 104 may automatically return the dehumidifier system 100 to the operating mode if the setup process is not completed within 2 minutes.

A number of settings of the dehumidifier system 100 may be set from within the setup mode:

a. Fan Speed Setup
When the dehumidifier system 100 initially enters the setup mode, the display 106 shows the selected fan speed icon. The up button 108c and the down button 108n may be used to change the fan speed.

b. Relative Humidity Setup
If the user presses the mode button 108b again, the relative humidity setting bar with numbers is displayed. The up button 108c and the down button 108n may be used to change the relative humidity set-point. Relative humidity blocks in the setting bar are shown as solid and flash on the display 106 according to the selected relative humidity set-point chosen by the user. If the relative humidity set-point is being increased and the relative humidity bar attains the highest number of blocks possible, the dehumidifier 100 system switches to a fan-only mode and the compressor shuts down. If the relative humidity set-point is being decreased and the relative humidity bar attains the lowest number of blocks possible, the dehumidifier system 100 switches to a continuous mode and the compressor remains on at all times subject to any preprogrammed maximum duty cycle to avoid freezing.

c. Temperature Unit
If the user presses the mode button 108b again, a temperature reading is displayed in either degrees Celsius or degrees Fahrenheit. The up button 108c and the down button 108n may be used to toggle the displayed unit between Celsius and Fahrenheit.

d. Buzzer Setup
If the user presses the mode button 108b again, buzzer setup is activated. The up button 108c and the down button 108n may be used to set the buzzer on or off and to select which alarms, if any, are enabled.

e. Exit from Setup-Mode
Pressing the mode button 108b again returns the dehumidifier system 100 to the operating mode.

The remote control and sensing device 104 may also provide for operation of the dehumidifier system 100 in a yard mode and/or a self-testing mode.

The remote control and sensing device 104 may have two additional operating modes. In one example, the remote control and sensing device 104 may be configured to control either a single dehumidifier system 100 or multiple dehumidifiers similar to the dehumidifier system 100, simultaneously. These two modes of operation are referred to as “one to one” (e.g., a single remote control and sensing device 104 controlling a single dehumidifier system 100) and “one to all” (e.g., a single remote control and sensing device 104 controlling a multiple dehumidifier systems). The remote control and sensing device 104 may be toggled between one to one mode and one to all mode with an easy program change using a combination of the buttons 108 on the remote control and sensing device 104 and the switches 120 on the receiver board 105.

5. One to All Mode

The one to all mode may be entered when the remote control and sensing device 104 and the receiver board 105 are off. If the user presses the up button 108c and the mode button 108b at the same time on the remote control and sensing device 104 followed by the power button 108a, the remote control and sensing device 104 enters the one to all mode. In the one to all mode, all receiver boards 105 within range of the remote control and sensing device 104 will receive commands and be controlled by the remote control and sensing device 104.

6. One to One Mode

The one to one mode may be entered when the remote control and sensing device 104 and the receiver board 105 are off. If the user presses the up button 108c and the mode button 108b at the same time on the remote control and sensing device 104 followed by the fan speed switch 120n on the receiver board 105, the receiver board 105 emits a beep. The remote control and sensing device 104 and the receiver board 105 are now in one to one mode. In the one to one mode, the remote control and sensing device 104 will only control this specific receiver board 105.

To facilitate the one to all and one to one modes, the receiver board 105 may be designed so that the manufacturing process repeats a unique unit code every 500 units in the numbering process. As such, every remote control and sensing device 104 that is manufactured may have the ability to control any dehumidifier system 100 (e.g., the remote control and sensing device 104 is capable of addressing all 500 unique unit codes stored in different receiver boards 105).

In one example, a 315 MHz carrier signal may be employed by the remote control and sensing device 104 in both of the one to one and the one to all modes. Instructions emitted from the remote control and sensing device 104 to the receiver board 105 comprises 2 parts: (i) an address code that indicates either the one to one mode or the one to all mode; and (ii) a string indicating a unique unit code.

In the one to one mode, the remote control and sensing device 104 emits a set of instructions including the address code indicating the one to one mode and the unique unit code. Once the receiver board 105 receives the set of instructions, the receiver board 105 compares the unique unit code received with the unique unit code stored in the receiver board 105. If the two unique unit codes are equal, control information in the set of instructions transmitted by remote control and sensing device 104 is processed by the receiver board 105.

In the one to all mode, the remote control and sensing device 104 emits instructions including the address code that indicates one to all mode. Once one of the receiver boards 105 (e.g., many receiver boards 105 may be receiving the instructions) receives the address code, the receiver board 105 automatically processes the control information and operates accordingly. The receiver board 105 does not operationally respond to the instructions emitted from the remote control and sensing device 104 unless the instructions include either the one to all address code indicating the one to all mode or the unique unit code equal to the unique unit code stored in the receiver board 105.

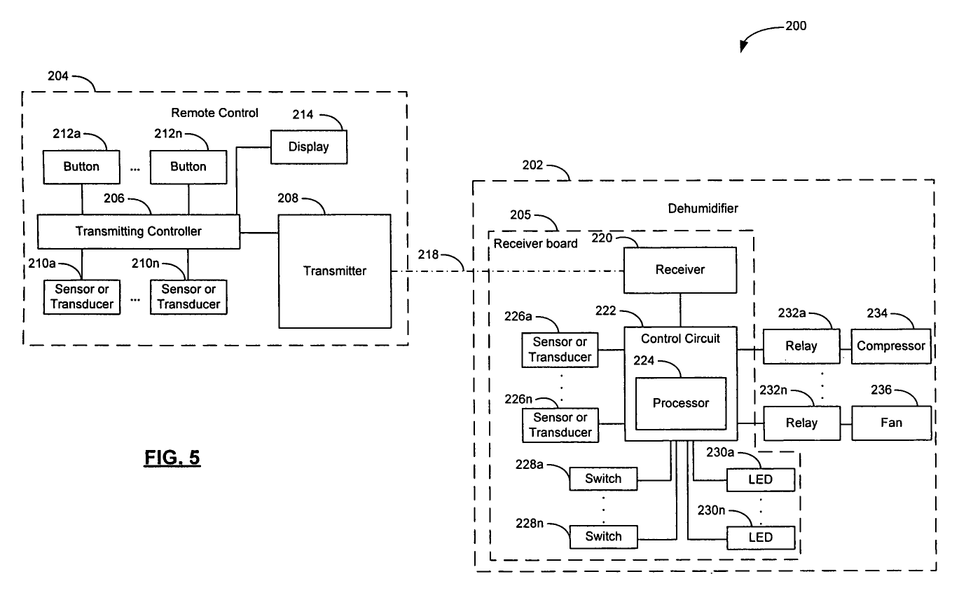

Referring to FIG. 3, a front perspective view of the receiver board 105 is shown. Referring to FIG. 4, a front plan view of the receiver board 105 is shown. The receiver board 105 generally comprises a number of switches 120, individually indicated as 120a, . . . 120n, and a number of lights or light emitting diodes (LEDs) 122, individually indicated as 122a, 122b, . . . 122n. In one embodiment, the switches 120 may include a power switch 120a and a fan speed switch 120n. The LEDs 122 may include a power on LED 122a, a bucket-full and/or low temperature indicator LED 122b, a high fan speed LED 122c, and a low fan speed LED 122n.

In one embodiment, the receiver board 105 serves a multitude of functions. The receiver board 105 functions as a rudimentary control device that allows the user of the dehumidifier system 100 to control the dehumidifier system 100 by entering settings on the main body 102 if the remote control and sensing device 104 is not convenient, has been misplaced, or has failed to function. Additionally, the receiver board 105 may serve as a docking station for the remote control and sensing device 104 should the user wish to place the remote control and sensing device 104 directly on the main body 102. As shown in FIG. 3, the receiver board 105 has a contoured housing with an elliptically shaped plateau in the center. The back of the remote control and sensing device 104 has a complementary recess for receiving the elliptically shaped contour of the housing. The remote control and sensing device 104 may snap into place on top of the receiver board 105. The receiver board 105 may also include a number of sensors or be connected to a number of sensors such as an ambient humidity sensor, an ambient temperature sensor, and/or a coil-temperature sensor. The receiver board 105 may also generate a full bucket alarm that asserts itself through the buzzer.

In one embodiment, the receiver board 105 may control the operating mode of the dehumidifier system 100. The mode of operation may be selected by the user or may be selected automatically by the receiver board 105 in response to the operating conditions of the dehumidifier system 100 and any settings set by the user. Example modes of operation may include the following:

1. Normal Mode

The dehumidifier system 100 may enter a normal mode of operation when first powered on. In this mode of operation, the receiver board 105 begins to function with the power LED 122a illuminated according to an instruction from the remote control and sensing device 104. If the remote control and sensing device 104 communicates an error for thirty minutes or more, the power LED 122a flashes and an audible alarm (e.g., the buzzer) is generated. After such a communications error, the user may press the power switch 120a and the fan speed switch 120n at the receiver board 105. The fan will then run at a speed according to the selection made with the fan speed switch 120n. In one example, the compressor may default to a pre-programmed duty cycle (e.g., the compressor remains on for fifty-two minutes and switches off for eight minutes each hour). When the fan speed is set to high on the remote control and sensing device 104 and no communications error exists, the high fan speed light 122c is on and the fan runs at high speed. When the fan speed is set to low on the remote control and sensing device 104, the low fan speed light 122n is on and the fan runs at low speed. In one example, the compressor is programmed to lag behind the fan by four minutes during the power-on sequence. Once the compressor quits running, a four minute interval may be needed before the compressor can be switched back on again. If a full bucket condition is detected for two seconds, the compressor and fan are turned off sequentially, the full bucket light 122b is illuminated, and the audible alarm (e.g., the buzzer) is generated once every hour. The user is able to toggle the buzzer on and off such that the buzzer is only able to sound if the buzzer is enabled from the remote control and sensing device 104.

2. Very Low Temperature Mode

This mode of operation is triggered if the ambient temperature at the main body 102 is below four degrees Celsius for four minutes or more. In this mode of operation, the fan and compressor shut down and the four LEDs 122 flash until the ambient temperature is above five degrees Celsius for at least eight consecutive minutes.

3. Low Temperature Mode

When the ambient temperature is lower than fifteen degrees Celsius and lasts for more than ten continuous minutes at the dehumidifier body 102, the receiver board 105 automatically enters low temperature mode and the low temperature light 122b begins to flash. In the low temperature mode, two conditions exist:

Condition A:
If the ambient humidity level does not become low enough to reach the set-point set by the user, the compressor runs at a predetermined duty cycle. In one example, the predetermined duty cycle may include a sequence of fifty-two minutes on followed by eight minutes off. At the end of the predetermined duty cycle, the receiver board 105 checks the coil temperature. If the coil temperature is above five degrees Celsius, the compressor continues to operate at this duty cycle until the humidity level reaches the set-point set by the user. If the coil temperature is below five degrees Celsius, the compressor will remain stopped and the defrost fan runs to defrost the coil for another eight minutes. At the end of the cycle, coil temperature is checked again.

Condition B:
If the ambient humidity level reaches the set-point set by the user within fifty-two minutes, the compressor stops, the defrost fan turns on, and the receiver board 105 runs the defrost cycle for four minutes. At the end of the four minutes, the coil temperature is checked. If the coil temperature is above five degrees Celsius, the compressor remains stopped and the defrost fan stops unless the ambient humidity level increases beyond the set-point set by the user. If the coil temperature is below five degrees Celsius, the receiver board 105 runs the defrost cycle for another four minutes and then checks the coil temperature again. Once the ambient temperature is above eighteen degrees Celsius for ten minutes, the receiver board 105 enters the normal mode.
   4. Defrost Mode:

When the coil temperature falls below two degrees Celsius for more than ten minutes, the receiver board 105 will automatically enter defrost mode. In defrost mode, the compressor will be turned off and the fan will continue running with the selected fan speed. The compressor remains off until the coil temperature rises to, for example, nine degrees Celsius or higher for more than ten minutes.

5. Fail-Safe Mode

If the coil temperature sensor and the ambient temperature sensor fail to work properly, the receiver board 105 will operate the dehumidifier system 100 in a fail-safe mode. The fan will run at the speed selected by the user and the compressor will cycle with a predetermined duty-cycle.

6. Self-Test Mode

A self-test mode may be entered while the dehumidifier system 100 power is off by pressing the fan-speed switch 120n and the power switch 120a at the same time for three seconds or more. All LEDs 122 will illuminate and the buzzer alarms for one second indicating that the receiver board 105 has entered the self-test mode. Various parts of the receiver board 105 may then be tested individually. For example, the user may use the fan-speed switch 120n to set the fan speed and then verify that the appropriate fan speed light 122c or 122n illuminates and the fan acquires the appropriate speed. The self-test mode is exited at any time by pressing the power switch 120a.

Referring to FIG. 5, a block diagram is shown illustrating a circuit topology of a remote controlled dehumidifier system 200 in accordance with an example embodiment of the present invention. The remote controlled dehumidifier system 200 generally comprises a dehumidifier 202, a remote control 204, and a receiver board 205.

The remote control 204 generally comprises a transmitting controller 206, a transmitter 208, a number of sensors or transducers 210, individually indicated as 210a, . . . 210n, a number of buttons 212, individually indicated as 212a, . . . 212n, and a display 214. The sensors 210 and the buttons 212 provide inputs to the transmitting controller 206. The transmitting controller 206 controls the transmitter 208 to transmit control signals to the dehumidifier 202. The control signals include operating instructions for the dehumidifier 202 determined by the transmitting controller 206 so as to achieve a certain comfort level at the location of the remote control 204, as set by a user of the remote control 204.

In one embodiment, the buttons 212 include a power button 212a, a mode button 212b, an up button 212c, and a down button 212n. The sensors or transducers 210 comprise an ambient temperature sensor 210a and an ambient relative humidity sensor 210n. The display 214 is connected to one or more outputs of the transmitting controller 206.

The remote control 204 communicates with the receiver board 205 of the dehumidifier 202 wirelessly, using infrared communications, radio frequency (RF) communications, or any other method of wireless communication known in the art. In one aspect of the present invention, RF communications is used so that a line-of-sight does not have to be maintained between the remote control 204 and the receiver board 205. A control signal transferred between the transmitter 208 and the receiver board 205 is indicated by a dashed line 218. In another example, the control signal 218 may be a WiFi compatible signal (e.g., compliant with the 802.11b or 802.11g wireless networking standards) such that the dehumidifier 202 is controllable by any WiFi enabled device. Any WiFi enabled device may be able to control or retrieve operating information from the dehumidifier system 200. Alternatively, the control signal 218 may be a wireless bus protocol signal such as a Bluetooth compatible signal enabling the dehumidifier 202 to be controllable by any Bluetooth enabled device (e.g., a PDA or cell phone). Any Bluetooth enabled device may be able to control or retrieve operating information from the dehumidifier system 200.

The dehumidifier 202 generally comprises a receiver 220, a control circuit 222, a processor 224, a number of sensors or transducers 226, individually indicated as 226a, . . . 226n, a number of switches 228, individually indicated as 228a, . . . 228n, a number of light emitting diodes (LEDs) 230, individually indicated as 230a, . . . 230n, a number of relays 232, individually indicted as 232a, . . . 232n, a compressor 234, and a fan 236. The receiver 220 receives the control signal 218 from the transmitter 208. The control circuit 222 includes the processor 224, which may be, in one example, an Application Specific Integrated Circuit (ASIC), a microcontroller, or any other suitable control circuit known in the art. The control circuit 222 is connected to the receiver 220, the sensors or transducers 226, the switches 228, the LEDs 230, and the relays 232. In one example, the sensors or transducers 226 comprise an ambient temperature sensor 226a and an ambient relative humidity sensor 226n located on the receiver board 205. However, the sensors 226 may also be positioned on the dehumidifier 202. The switches 228 may comprise a power switch 228a and a fan speed switch 228n. The LEDs 230 may comprise a power on LED 230a, bucket-full and/or low temperature indicator LED 230b, a high fan speed LED 230c, and a low fan speed LED 230n. In one embodiment of the present invention, the receiver 220, the sensors 226, the switches 228, and the LEDs 230 are located on the receiver board 205. However, any of the receiver 220, the sensors 226, the switches 228, and the LEDs 230 may be moved off of the receiver board 205 and placed on the dehumidifier 202 according to the design criteria of a particular application. The relays 232 may comprise a compressor relay 232a and a fan relay 232n. The compressor relay 232a controls the dehumidifier compressor 234 and the fan relay 232n controls the dehumidifier fan 236. The dehumidifier 202 may have more than one compressor and/or fan. For example, the dehumidifier 202 may have one fan for normal operation and a second fan for defrosting the coil.

In one embodiment, in operation the remote control 204 senses the ambient relative humidity in the area where the remote control 204 is positioned. The remote control 204 commands the dehumidifier 202 to operate until the relative humidity set-point set at the remote control 204 by the user is attained at the location of the remote control 204. The remote control 204 remotely programs the dehumidifier fan settings, relative humidity set-point, and audible full bucket alarm buzzer. The remote control 204 displays ambient relative humidity and temperature readings in the vicinity of the remote control 204 and/or the vicinity of the dehumidifier 202. The remote control 204 may have an option of displaying the temperature in either degrees Celsius or Fahrenheit. In one example, the remote control 204 also provides a compressor start delay for every cycle when the compressor 234 is required to start. The dehumidifier 202 may sense the dehumidifier 202 coil temperature and respond with deicer cycles if needed. The remote control 204 has built in dehumidifier function diagnostics routines. The remote control 204 also has an integrated program to operate specifically with the particular receiver board 205. Alternatively, the remote control 204 may be designed to operate with any receiver board, as described above. The remote control 204 also senses low temperatures (e.g., less than five degrees Celsius) and stops the dehumidifier 202 operation and flashes related information on the display 214 until the temperature increases. Once the temperature has increased, the remote control 204 commands the dehumidifier 202 operation to resume. The receiver board 205 is installed in the front grille of the dehumidifier 202. During normal operation, the receiver board 205 receives the RF control signal 218 from the remote control 204 in periodic intervals (e.g., every fifteen minutes).

The present invention may be embodied in other specific forms without departing from the spirit or characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

I claim:

1. A dehumidifier comprising:
a dehumidifier main body portion including a dehumidification system;
a receiver board mounted on the main body portion for controlling operation of the dehumidification system; and
a remote control including a control circuit for generating a control signal, the remote control including a transmitter for wirelessly transmitting the control signal to the receiver board,
wherein the remote control includes a sensor electrically coupled to the control circuit, the sensor generating a sensor signal in response to a physical condition sensed at the location of the remote control, wherein the control signal is based upon the sensor signal, and wherein the receiver board controls the dehumidification system in response to the control signal.

2. The dehumidifier according to claim 1, wherein the sensor comprises a humidistat.

3. The dehumidifier according to claim 1, wherein the sensor comprises a thermometer.

4. The dehumidifier according to claim 1, further comprising:
one or more buttons located on the remote control and coupled to the control circuit; and
a display located on the remote control and coupled to the control circuit, wherein a user of the dehumidifier inputs a set point using the one or more buttons, and wherein the control circuit generates the control signal based upon the sensor signal and the set point.

5. The dehumidifier according to claim 4, wherein the sensor comprises a humidistat and wherein the set point comprises an ambient humidity setting.

6. The dehumidifier according to claim 1, wherein the remote control is removably attachable to the receiver board.

7. The dehumidifier according to claim 1, further comprising:
a second sensor for sensing physical conditions at the dehumidifier main body portion, the second sensor being electrically coupled to the receiver board and generating a second sensor signal, wherein the receiver board controls operation of the dehumidification system in response to the control signal and the second sensor signal.

8. The dehumidifier according to claim 7, wherein the second sensor comprises a coil temperature sensor for triggering a defrost mode of operation.

9. The dehumidifier according to claim 7, wherein the second sensor comprises a level sensor for triggering a full bucket condition.

10. The dehumidifier according to claim 7, wherein the second sensor comprises a humidistat supplying the second sensor signal to the receiver board and the receiver board controls the dehumidification system in response to either of the control signal and second sensor signal.

11. The dehumidifier according to claim 1, wherein the transmitter wirelessly transmits the control signal to the receiver board using a wireless communication link selected from the group consisting of a radio frequency (RF) signal, a networking communication link, and a wireless bus protocol communication link.

12. The dehumidifier according to claim 1, further comprising:
one or more sensors electrically coupled to the receiver board, the one or more sensors generating additional sensor signals supplied to the receiver board in response to physical conditions sensed at the location of the receiver board.

13. The dehumidifier according to claim 1, further comprising:
one or more switches electrically coupled to the receiver board, the one or more switches for controlling the operation of the dehumidification system in response to settings set by a user at the location of the dehumidifier main body portion.

14. The dehumidifier according to claim 1, further comprising:
one or more light emitting diodes (LEDs) electrically coupled to the receiver board, said one or more LEDs indicating various operating modes of the dehumidification system.

15. The dehumidifier according to claim 1, wherein the receiver board comprises a processor for receiving the control signal and controlling the dehumidification system.

16. The dehumidifier according to claim 15, wherein the processor comprises an application specific integrated circuit (ASIC).

17. The dehumidifier according to claim 15, wherein the processor comprises a microcontroller.

18. The dehumidifier according to claim 1, further comprising:
a housing for the receiver board, the housing having a front face;
an elevated contour located on the front face of the housing; and
a recess complementary to the elevated contour and located on the back of the remote control such that the remote control is removably attachable to the housing of the receiver board.

19. The dehumidifier according to claim 1 wherein the dehumidifier forms part of a dehumidification network, the dehumidification network further comprising:
one or more additional dehumidifier main body portions each including dehumidification systems; and
one or more additional receiver boards mounted on the one or more additional dehumidifier main body portions, each for controlling operation of the respective dehumidification systems,
wherein the control signal further comprises an address code and a unique unit code and each of the receiver board and the one or more additional receiver boards further comprises a programmed unique unit code.

20. The dehumidification network according to claim 19, wherein the address code comprises two different codes selected from the group consisting of a one to one mode and a one to all mode.

21. The dehumidification network according to claim 20, wherein the receiver board and the one or more additional receiver boards all operate in response to the control signal when the address code indicates the one to all mode.

22. The dehumidification network according to claim 20, wherein the receiver board and the one or more additional receiver boards individually operate in response to the control signal when the address code indicates one to one mode and the unique unit code equals the programmed unique unit code.
